(19) United States
(12) Patent Application Publication
(10) Pub. No.: US 2011/0025002 A1
(43) Pub. Date: Feb. 3, 2011

(54) Wheel Assembly and Wheeled Shoes having the Same

(75) Inventor: Yong Jae Park, Gyeonggi-do (KR)

Correspondence Address: DORITY & MANNING, P.A., POST OFFICE BOX 1449, GREENVILLE, SC, 29602-1449, US

(73) Assignee: ROTA SPORTS CO., LTD., Gyeonggi-do (KR)

(21) Appl. No.: 12/920,531

(22) PCT Filed: Mar. 2, 2009
(86) PCT No.: PCT/KR09/01001

§ 371 Date: Oct. 4, 2010

(30) Foreign Application Priority Data
Mar. 4, 2008 (KR) 10-2008-0020149

(51) Int. Cl. A63C 17/04; B60B 19/12

(52) U.S. Cl. 280/11.19; 280/29

(57) ABSTRACT

Disclosed are a wheel assembly and wheeled shoes having the same. According to an embodiment of the invention, a wheel assembly, being installed in a way to allow wheel(s) to be retracted into or pulled out of an inner space, includes: a base block fixed in the inner space; a wheel support, to which the wheel(s) is (are) rotatably coupled and which is pivotably mounted on the base block about a first axis, thus pivoting between a first position where the wheel(s) is (are) retracted into the inner space and a second position where the wheel(s) is (are) pulled out of the inner space; and a positioner, which enables the wheel support to pivot between the first position and the second position and fixes the position of the wheel support to prevent the wheel support from pivoting on the base block when the wheel support is located in the first position or in the second position.

### CROSS-REFERENCE TO RELATED APPLICATION

This application claims priority to and the benefit of Korean Patent Application No. 10-2008-0020149 filed in the Korean Intellectual Property Office on Mar. 4, 2008, the entire contents of which are incorporated herein by reference.

### BACKGROUND OF THE INVENTION

(a) Field of the Invention

The present invention relates to a wheel assembly and wheeled shoes having the same, and more particularly to a wheel assembly and wheeled shoes having the same, in which a location of a wheel can be fixed at a position where the wheel is retracted into or pulled out of an inner space.

(b) Description of the Related Art

Wheeled shoes, mounted with wheels at rear portions thereof and enable skating by rolling the wheels, function as skates through a rolling operation of the wheels of the rear portions while walking. Most of the wheeled shoes have the wheels exposed to the outside at their rear portions. Therefore, a front portion having no wheel and the rear portion having the wheels are all in contact with the ground to prevent slip during the walking, but the front portion is raised and the wheels at the rear portions are rolled during the skating. However, since the wheels protrude at the rear portions of the wheeled shoes, it causes unnatural walking and a dangerous accident of slipping due to the wheel while ascending and descending the stairs or the like even though the walking is achieved in the state that both front and rear portions of the shoes are in contact with the ground.

To solve this inconvenience and use the wheeled shoes conveniently and safely, there have been known wheeled shoes having an improved structure that the wheel is pulled out of an inner space during the skating or retracted into the inner space during the walking.

However, such improved wheeled shoes may have various problems when a position of a wheel support is not stably fixed at a position where the wheel is pulled out of or retracted into the inner space. In other words, if the position of the wheel support is not firmly fixed at the position where the wheel is retracted, the wheel support may be released when getting an external shock and make noise owing to friction with the ground or its housing. Further, repetitive shocks due to the friction may cause a trouble. Also, if the position of the wheel support is not firmly fixed at the position where the wheel is pulled out, a load is not effectively distributed through the wheel, and straight rolling of the wheel is deteriorated by small shakes of the wheel support.

### SUMMARY OF THE INVENTION

Accordingly, the present invention is conceived to solve the foregoing problems, and an aspect of the present invention is to provide a wheel assembly and wheeled shoes having the same, which includes a positioner capable of fixing a position of a wheel even though an external shock is given at respective positions where the wheel is retracted into or pulled out of an inner space, so that the wheel can be prevented from being retracted or pulled out due to undesired malfunction, thereby preventing a negligent accident.

Another aspect is to provide a wheel assembly and wheeled shoes having the same, in which a position of a wheel is stably fixed to prevent a little position change of the wheel, thereby enhancing rolling of the wheel.

An exemplary embodiment of the present invention provides a wheel assembly, in which a wheel is installed to be retracted into or pulled out of an inner spaced, the wheel assembly including: a base block fixed in the inner space; a wheel support to which the wheel is rotatably coupled and which is installed to be rotatable about a first axis with regard to the base block and pivots between a first position where the wheel is retracted into the inner space and a second position where the wheel is pulled out of the inner space; and a positioner which allows the wheel support to be pivotable between the first position and the second position and fixes a position of the wheel support to prevent the wheel support from rotating with regard to the base block when the wheel support is located at the first position or the second position.

The positioner may include a shaft member rotatable about the first axis, a protrusion provided in one of the shaft member and the wheel support, and a first groove provided in the other one of the shaft member and the wheel support and coupling with the protrusion, and the wheel support may pivot between the first position and the second position as the shaft member rotates about the first axis in a state that the protrusion and the first groove are coupled.

The shaft member may be movable along the first axis; the first groove may be formed passing through the wheel support; the protrusion may be extended toward the wheel support and formed longer than a depth of the first groove; and the positioner may include a second groove provided in the base block and formed at a position corresponding to the first groove when the wheel support is located at the first position, and a third groove provided in the base block as being spaced apart from the second groove and formed at a position corresponding to the first groove when the wheel support is located at the second position, the protrusion being coupled to the first groove and the second groove when the wheel support is located at the first position, and coupled to the first groove and the third groove when the wheel support is located at the second position so that the position of the wheel support is fixed.

The wheel assembly may further include a first elastic member that is put on the shaft member and disposed concentrically with the shaft member and elastically urge the shaft member in a direction that the protrusion is coupled to the second groove or the third groove.

The third groove may be formed passing through the base block; and the positioner may include a fourth groove formed in the wheel support, a bar member disposed to slide along the third groove and having one end part capable of contacting the protrusion, and a second elastic member elastically urging the bar member in a direction of pushing the protrusion out of the third groove, the bar member being pushed in an opposite direction to the elastically urging direction of the second elastic member when the wheel support is located at the second position, so that the other end part of the bar member can be coupled to the fourth groove.

The positioner may include a shaft member rotatable about the first axis, a first uneven part provided at one end part of the shaft member, and a second uneven part provided at one end part of the wheel support and engaging with the first uneven part, and the wheel support may rotate between the first position and the second position by rotating the shaft member about the first axis in a state that the first uneven part and the second uneven part are engaged with each other.

The shaft member may be movable along a direction of the first axis; and the position determiner may further include an uneven member formed with a through hole in which the shaft member is inserted in the direction of the first axis and having an uneven part on an outer periphery, a third uneven part formed in the base block and always engaging with the uneven member and selectively engaging with the first uneven part, and a fourth uneven part provided in the other end part of the wheel support and selectively engaging with the uneven member, the first uneven part being engaged with the second uneven part and the third uneven part and the uneven member being engaged with the fourth uneven part to fix the position of the wheel support when the wheel support is located at the first position or the second position, and the first uneven part being released from the third uneven part and the uneven member being released from the fourth uneven part to make the wheel support be rotatable when the wheel support pivots between the first position and the second position.

The wheel assembly may further include a first elastic member that is put on the shaft member and disposed concentrically with the shaft member and elastically urges the shaft member in a direction that the first uneven part engages with the third uneven part.

The wheel support may include a first support member pivotable on the first axis with regard to the base block, and a second support member having one end part coupled being pivotable on a second axis intersecting the first axis with regard to the first support member and the other end part to which the wheel is rotatably coupled, the second support member pivoting on the second axis with regard to the first support member while the first support member rotates between the first position and the second position.

Another exemplary embodiment of the present invention provides wheeled shoes including an outer cover a wearer's foot a sole coupled to a bottom of the outer cover to contact the ground; and the foregoing wheel assembly installed to be retracted into or pulled out of an inner space provided in the sole.

As described above, according to an exemplary embodiment of the present invention, there are provided the wheel assembly and the wheeled shoes having the same, in which the position of the wheel support is stably fixed at the positions where the wheel is retracted into or pulled out of the inner space, so that the wheel can be prevented from being retracted or pulled out due to undesired malfunction, thereby preventing a negligent accident.

Also, there are provided the wheel assembly and the wheeled shoes having the same, in which coupling force for fixing the position of the wheel support is increased at the second position where the wheel is exposed to the outside and holds a shoe wearer's weight, so that the wheel cannot be shaken while rolling, and the rolling of the wheel can be enhanced.

### BRIEF DESCRIPTION OF THE DRAWINGS

FIG. 1 is a perspective view of a wheeled shoe according to an exemplary embodiment of the present invention;

FIG. 2 is a perspective view showing that a wheel assembly is located at a first position according to an exemplary embodiment of the present invention;

FIG. 3 is an exploded perspective view of the wheel assembly of FIG. 2;

FIG. 4 is a perspective view showing that a second support member of the wheel assembly of FIG. 2 is pivoted with respect to a first support member;

FIG. 5 is a sectional view of FIG. 2, taken along line V-V;

FIG. 6 is a sectional view of FIG. 1, taken along line VI-VI;

FIG. 7 is a sectional view of FIG. 1, taken along line VII-VII;

FIG. 8 is a perspective view of a base block, a wheel support and a shaft member of a wheel assembly according to another exemplary embodiment of the present invention;

FIG. 9 is a sectional view showing that the wheel assembly of FIG. 8 is located at a first position or a second position; and

FIG. 10 is a sectional view showing that the wheel assembly of FIG. 8 is located between the first position and the second position.

### DETAILED DESCRIPTION OF THE EMBODIMENTS

Hereinafter, exemplary embodiments of a wheel assembly and wheeled shoes having the same according to the present invention will be described in more detail with reference to accompanying drawings.

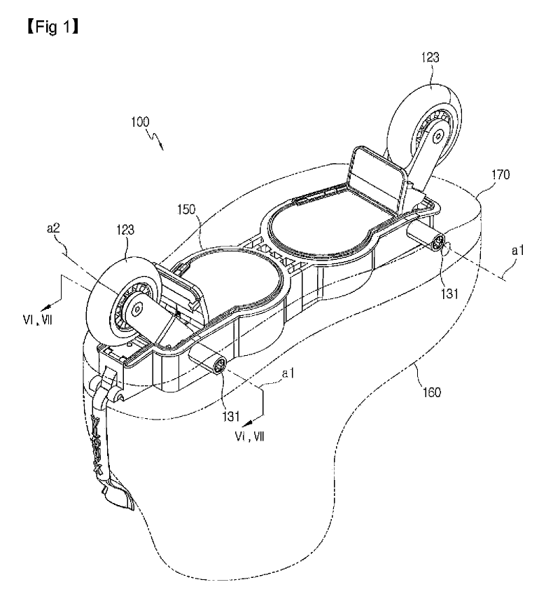

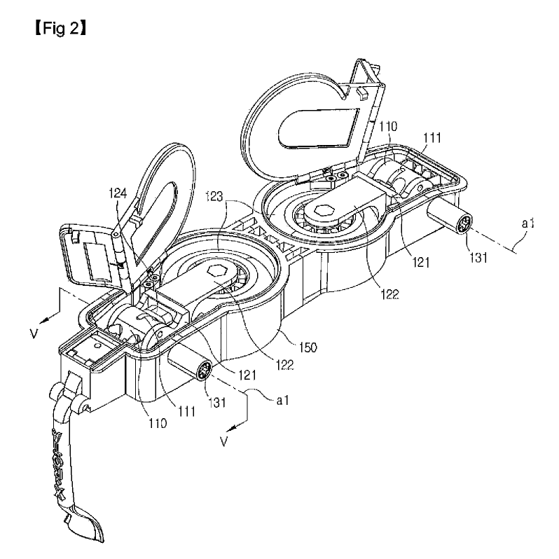

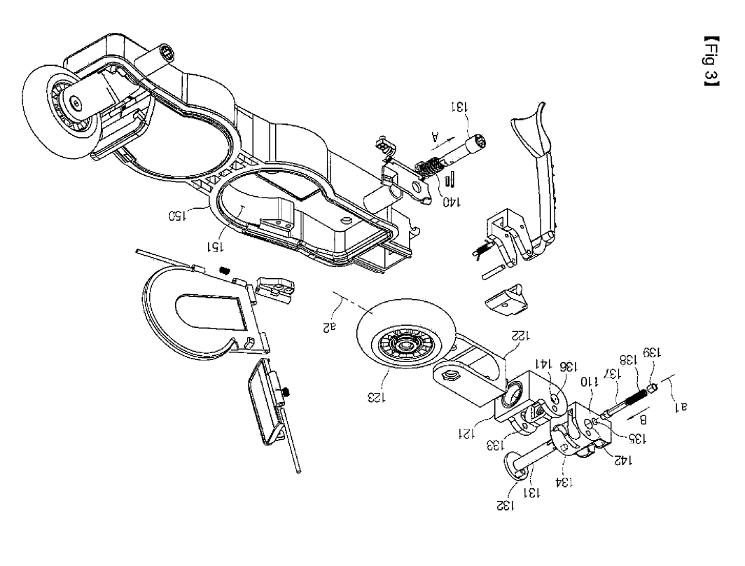

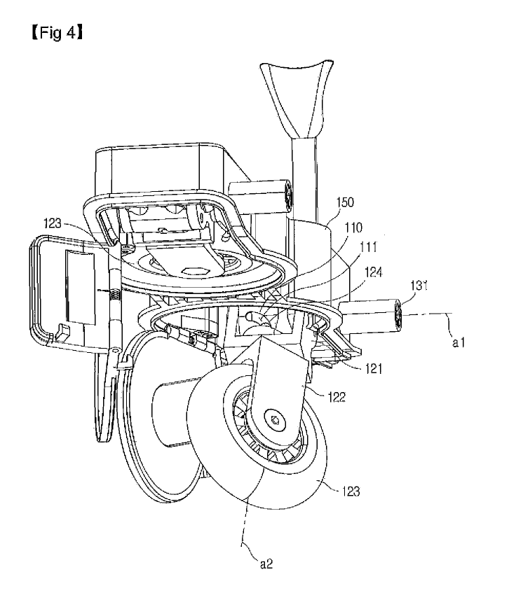

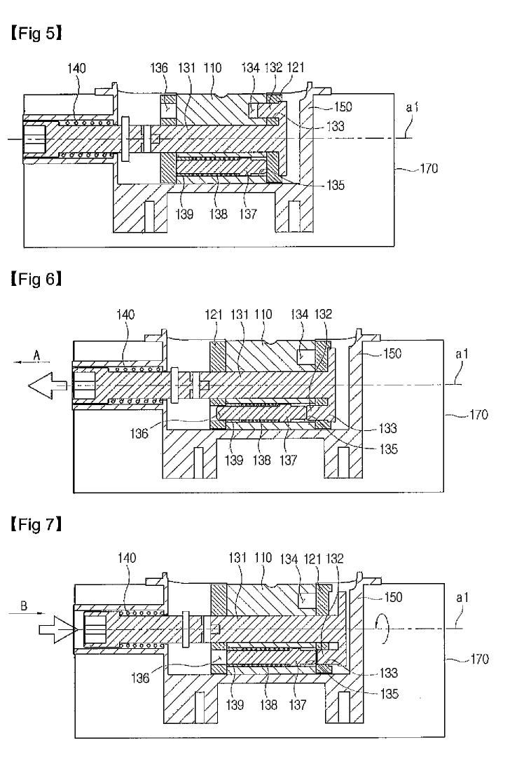

FIG. 1 is a perspective view of a wheeled shoe according to an exemplary embodiment of the present invention; FIG. 2 is a perspective view showing that a wheel assembly is located at a first position according to an exemplary embodiment of the present invention; FIG. 3 is an exploded perspective view of the wheel assembly of FIG. 2; FIG. 4 is a perspective view showing that a second support member of the wheel assembly of FIG. 2 is pivoted with respect to a first support member; FIG. 5 is a sectional view of FIG. 2, taken along line V-V; FIG. 6 is a sectional view of FIG. 1, taken along line VI-VI; and FIG. 7 is a sectional view of FIG. 1, taken along line VII-VII.

Referring to FIGS. 1 to 7, a wheeled shoe 100 in this exemplary embodiment includes an outer cover 160, a sole 170, a housing 150 and a wheel assembly, in which a wheel 123 is installed to be retracted into and pulled out of an inner space 151 of the sole 170.

The outer cover 160 covers a shoe wearer's foot, and the sole 170 is coupled to a bottom of the outer cover 160 and contacts the ground during a shoe wearer' walking. The housing 150 is coupled to the sole 170 and includes the inner space 151 capable of accommodating the wheel assembly to be described later. The inner space 151 may be an inner space provided in the housing 150 according to this exemplary embodiment, or an inner space directly formed in the sole 170 without the housing.

The wheel assembly is retracted into the inner space 151 formed in the housing 150 so that the wheel 123 can be retracted into or pulled out of the inner space 151, which includes a base block 110, a wheel support and a positioner.

The base block 110 is to support the wheel support being rotated, which is fixed in the inner space 151 of the housing 150.

The wheel support supports the wheel 123 and is pivotable between the first position (refer to FIG. 2) where the wheel 123 is retracted in the inner space 151 and a second position (refer to FIG. 1) where the wheel 123 is pulled out of the inner space 151, which includes a first support member 121 and a second support member 122.

The first support member 121 has a first end part pivotable on a first axis a1 with regard to the base block 110 and coupled to the base block 110, and a second end part coupled to the second support member 122. Here, the first axis a1 is disposed to pass through the base block 110. The second support member 122 has a first end part pivotable on a second axis a2 intersecting the first axis a1 with regard to the first support member 121 and coupled to the second end part of the first support member 121, and a second end part to which the wheel 123 is rotatably coupled.

The second support member 122 is provided with a cam unit 124 shaped like a protrusion, and the base block 110 is provided with a cam follower unit 111 having an “L” shape bent at an angle of about 90 degrees in the middle thereof and grooved. In the state that the cam unit 124 is inserted in the cam follower unit 111, the first support member 121 rotates with respect to the base block 110. While the first support member 121 pivots between the first position (see FIG. 2) and the second position (see FIG. 1), the second support member 122 rotates with regard to the first support member 121 along the shape of the cam follower unit 111 with respect to the second axis a2. When the first support member 121 and the second support member 122 are located at the second position, the wheel 123 and the second support member 122 are disposed to go in a shoe wearer's working direction. On the other hand, when the first support member 121 and the second support member 122 are located at the first position, the second support member 122 rotates with regard to the first support member 121 so that the wheel 123 can be accommodated in the inner space 122 as being laid horizontally. Thus, it is effective in reducing the inner space 151 in which the wheel support is accommodated.

The positioner allows the wheel support to pivot between the first position and the second position, and fixes the position of the wheel support in order to prevent the wheel support from pivoting with regard to the base block 110 when the wheel support is located at the first position or the second position. The positioner includes a shaft member 131, a first groove 133, a protrusion 132, a second groove 134, a third groove 135, a first elastic member 140, a fourth groove 136, a bar member 137, and a second elastic member 138.

The shaft member 131 is rotatable about the first axis a1, and shaped like a bar disposed to be movable along the first axis a1. Also, the shaft member 131 is inserted passing through a through hole 141 formed in the first support member 121 and a through hole 142 formed in the base block 110. In this exemplary embodiment, the shaft member 131 is divided into two members for facilitating assembly, but may be provided as a single member.

The protrusion 132 is provided in one end part of the shaft member 131 and extended toward the first support member 121. The first groove 133 is formed at one side of the first support member 121, in which the protrusion 132 is inserted in the first groove 133. If the shaft member 131 is rotated about the first axis a1 in the state that the protrusion 132 formed in the shaft member 131 is inserted in the first groove 133 formed in the first support member 121, the first support member 121 rotates about the first axis a1 with regard to the base block 110. In this exemplary embodiment, the first groove 133 is formed passing through the first support member 121 at one side of the first support member 121, and the protrusion 132 is formed longer than the depth of the first groove 133.

The second groove 134 is formed at a position corresponding to the first groove 133, i.e., a concentric position with the first groove 133 when the wheel support is located at the first position, as a circular groove provided at one side of the base block 110. Also, the third groove 135 is provided being spaced apart from the second groove 134 in an arc direction with respect to the first axis a1, as a circular groove provided at one side of the base block 110. The third groove 135 is formed at a position corresponding to the first groove 133, i.e., a concentric position with the first groove 133 when the wheel support is located at the second position. In this exemplary embodiment, the third groove 135 is formed passing through the base block 110.

The first elastic member 140 is coupled to and put on the shaft member 131 as being disposed concentrically with the shaft member 131. In this exemplary embodiment, a spring is used as the first elastic member 140. The first elastic member 140 has a first end part supported by the housing 150, and a second end part supported by the second end part of the shaft member 131. Thus, the protrusion 132 passes through the first groove 133 and elastically urges the second end part of the shaft member 131 in a direction “A” of coupling with the second groove 134 when the wheel support is located at the first position, and passes through the first groove 133 and elastically urges the second end part of the shaft member 131 in a direction “A” of coupling with the third groove 135 when the wheel support is located at the second position.

The fourth groove 136 is formed at the other side of the first support member 121, and the bar member 137 to be described later is inserted in the fourth groove 136 when the wheel support is located at the second position.

The bar member 137 is shaped like a bar that can slide along the third groove 135. The bar member 137 has a first end part to contact the protrusion 132 as the protrusion 132 is inserted in the third groove 135 when the wheel support is located at the second position. Further, a ring member 139 having a hollow shape is put on the third groove 135 at an opposite side to the side where the protrusion 132 is inserted, and thus a second end part of the bar member 137 is disposed to pass through the ring member 139.

The second elastic member 138 is coupled to and put on the bar member 137 so as to be disposed concentrically with the bar member 137. In this exemplary embodiment, a spring is used as the second elastic member 138. The second elastic member 138 has a second end part supported by the ring member 139. Thus, the second elastic member 138 elastically urges the bar member 137 in a direction of pushing the protrusion 132 output of the third groove 135.

Below, operation of the wheel assembly configured as described above according to an exemplary embodiment of the present invention will be schematically described with reference to FIGS. 1 trough 7.

Referring to FIG. 5, when the wheel support is located at the first position where the wheel 123 is retracted into the inner space 151 of the housing 150, the protrusion 132 passes through the first groove 133 and an end part of the protrusion 132 exposed from the first groove 133 is inserted in the second groove 134. Thus, the position of the first support member 121 is fixed at the first position where the first support member 121 is prevented from rotating with regard to the base block 110.

Referring to FIG. 6, when the wheel support is located at the second position where the wheel 123 is pulled out of the inner space 151 of the housing, the protrusion 132 passes through the first groove 133 and the end part of the protrusion 132 exposed from the first groove 133 is inserted in the third groove 135, so that the position of the first support member 121 can be fixed at the second position where the first support member 121 is prevented from rotation with regard to the base block 110. Also, the protrusion 132 is inserted in the third groove 135 and pushes the first end part of the bar member 137, so that the second end part of the bar member 137 can be inserted in the fourth groove 136 as the bar member 137 slides in the direction “A”. Thus, the first support member 121 and the base block 110 are coupled by the protrusion 132 and the bar member 137 at the second position, thereby strengthening force of fixing the position of the first support member 121 to the second position.

Referring to FIG. 7, the first support member 121 is located at a position between the first position and the second position. To separate the first support member 121 from the second position, the protrusion 132 pushes the shaft member 131 in a direction “B” of coming out of the third groove 134. As the shaft member 131 slides along the first axis a1, the protrusion 132 comes out of the third groove 131 but keeps inserted in the first groove 133. The bar member 137 being in contact with the protrusion 132 slides in the direction “B” by the elasticity of the second elastic member 138. As the bar member 137 slides, the second end part of the bar member 137 comes out of the fourth groove 136. Because the protrusion 132 comes out of the third groove 134 but keeps inserted in the first groove 133, the first support member 121 pivots on the first axis a1 with regard to the base block 110 between the first position and the second position when the shaft member 131 is rotated about the first axis a1.

With the foregoing configuration, the wheel assembly and the wheeled shoes having the same according to an exemplary embodiment can stably fix the position of the wheels at the respective positions where the wheels are retracted into or pulled out of the inner space even when getting an external shock, so that the wheel can be prevented from being retracted or pulled out due to undesired malfunction, thereby having an effect on preventing a negligent accident.

Also, in the second position where the wheel is exposed to the outside and holds a shoe wearer's weight, the first support member and the base block are coupled by the protrusion and the bar member, thereby increasing coupling force for fixing the position of the wheel support. Accordingly, the wheel is not shaken while rolling, and thus the rolling of the wheel is enhanced.

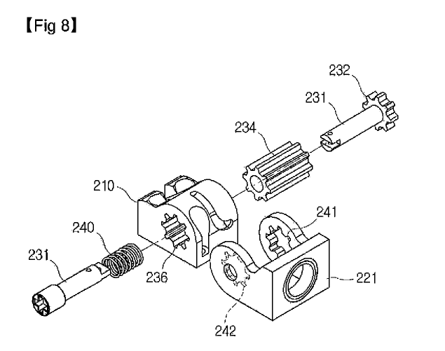

Meanwhile, FIG. 8 is a perspective view of a base block, a wheel support and a shaft member of a wheel assembly according to another exemplary embodiment of the present invention. In FIG. 8, elements, denoted by like reference numerals as those for the elements shown in FIGS. 1 to 7, have the same configurations and functions, and thus detailed descriptions thereof will be omitted.

Referring to FIG. 8, a base block 210 in this exemplary embodiment corresponds to the base block 110 of FIG. 3, a first support member 221 in this exemplary embodiment corresponds to the first support member 121 of FIG. 3, and a shaft member 231 in this exemplary embodiment corresponds to the shaft member 131 of FIG. 3.

In this exemplary embodiment, the positioner includes the shaft member 231, a first uneven part 232, a second uneven part 241, an uneven member 234, a third uneven part 236, a fourth uneven part 242 and a first elastic member 240.

The shaft member 231 is rotatable about the first axis a1, and shaped like a bar disposed movably along the first axis a1. The first uneven part 232 is provided at a first end part of the shaft member 231, the second uneven part 241 is provided in the wheel support, i.e., the first support member 221 and passes through the first end part of the first support member 221, thereby engaging with the first uneven part 232. If the shaft member 231 is rotated about the first axis a1 in the state that the first uneven part 232 formed in the shaft member 231 is engaged with the second uneven part 241 formed in the first support member 221, the first support member 221 rotates about the first axis a1 with regard to the base block 210.

The uneven member 234 is formed with a through hole at the center thereof in a direction of the first axis a1, and the shaft member 231 is inserted in the through hole. The uneven member 234 is formed with an uneven part on an outer periphery thereof to be engaged with the third uneven part 236 to be described later. The third uneven part 236 is formed passing through the base block 210. The third uneven part 236 always engages with the uneven part formed on the outer periphery of the uneven member 234, but selectively engages with the first uneven part 232. The fourth uneven part 242 is provided in the second end part of the first support member 221, i.e., an opposite side to the part where the second uneven part 241 is formed, and selectively engages with the uneven member 234.

The first elastic member 240 is put on and coupled to the shaft member 231 so as to be disposed concentrically with the shaft member 231. In this exemplary embodiment, a spring is used as the first elastic member 240. The first elastic member 240 has a first end part supported by the housing 150, and a second end part supported by the second end part of the shaft member 231. When the wheel support is located at the first position or the second position, the first elastic member 240 elastically urges the shaft member 231 in a direction that the first uneven part 232 engages with the third uneven part 236.

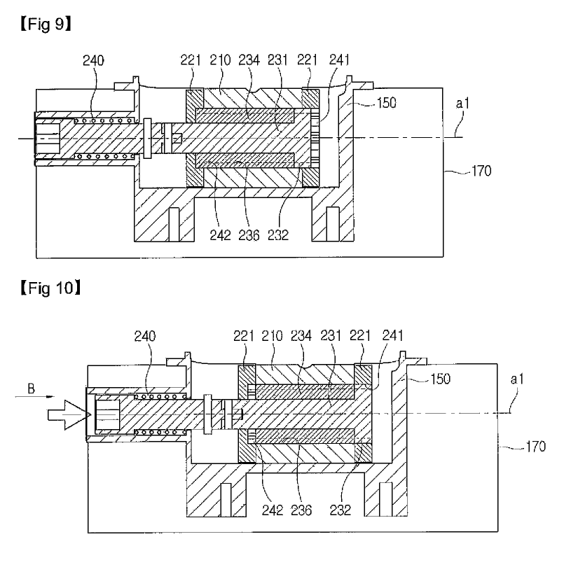

As shown in FIG. 9, when the first support member 221 is located at the first position or the second position, the first uneven part 232 engages with the second uneven part 241 and the third uneven part 236, and the uneven member 234 engages with the fourth uneven part 242. Therefore, the first support member 221 does not pivot anymore with regard to the base block 210 and the position thereof is fixed.

In the meantime, as shown in FIG. 10, when the first support member 221 pivots between the first position and the second position, the first uneven part 232 is released from the third uneven part 236 and engages with only the second uneven part 241, and the uneven member 234 is released from the fourth uneven part 242 and engages with only the third uneven part 236, so that the first support member 221 can rotate with regard to the base block 210.

In the foregoing exemplary embodiments, the protrusion is formed in the shaft member, and the first groove is formed passing through the first end part of the first support member, but not limited thereto. Alternatively, the protrusion may be formed in the first support member, and the first groove may be formed passing through the first end part of the shaft member.

In the wheel assembly and the wheeled shoes having the same, the position of the wheel support is stably fixed at the positions where the wheel is retracted into or pulled out of the inner space, so that the wheel can be prevented from being retracted or pulled out due to undesired malfunction, thereby preventing a negligent accident.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A wheel assembly, in which a wheel is installed to be retracted into or pulled out of an inner spaced, the wheel assembly comprising:
a base block fixed in the inner space;
a wheel support to which the wheel is rotatably coupled and which is installed to be rotatable about a first axis with regard to the base block and pivots between a first position where the wheel is retracted into the inner space and a second position where the wheel is pulled out of the inner space; and
a positioner which allows the wheel support to be pivotable between the first position and the second position and fixes a position of the wheel support to prevent the wheel support from rotating with regard to the base block when the wheel support is located at the first position or the second position.

2. The wheel assembly according to claim 1, wherein the positioner comprises a shaft member rotatable about the first axis, a protrusion provided in one of the shaft member and the wheel support, and a first groove provided in the other one of the shaft member and the wheel support and coupling with the protrusion, and
the wheel support pivots between the first position and the second position as the shaft member rotates about the first axis in a state that the protrusion and the first groove are coupled.

3. The wheel assembly according to claim 2, wherein the shaft member is movable along the first axis; the first groove is formed passing through the wheel support; the protrusion is extended toward the wheel support and formed longer than a depth of the first groove; and the positioner comprises a second groove provided in the base block and formed at a position corresponding to the first groove when the wheel support is located at the first position, and a third groove provided in the base block as being spaced apart from the second groove and formed at a position corresponding to the first groove when the wheel support is located at the second position,
the protrusion being coupled to the first groove and the second groove when the wheel support is located at the first position, and coupled to the first groove and the third groove when the wheel support is located at the second position so that the position of the wheel support is fixed.

4. The wheel assembly according to claim 3, further comprising a first elastic member that is put on the shaft member and disposed concentrically with the shaft member and elastically urges the shaft member in a direction that the protrusion is coupled to the second groove or the third groove.

5. The wheel assembly according to claim 3, wherein the third groove is formed passing through the base block; and the positioner comprises a fourth groove formed in the wheel support, a bar member disposed to slide along the third groove and having one end part capable of contacting the protrusion, and a second elastic member elastically urging the bar member in a direction of pushing the protrusion out of the third groove,
the bar member being pushed in an opposite direction to the elastically urging direction of the second elastic member when the wheel support is located at the second position, so that the other end part of the bar member can be coupled to the fourth groove.

6. The wheel assembly according to claim 1, wherein the positioner comprises a shaft member rotatable about the first axis, a first uneven part provided at one end part of the shaft member, and a second uneven part provided at one end part of the wheel support and engaging with the first uneven part, and
the wheel support rotates between the first position and the second position by rotating the shaft member about the first axis in a state that the first uneven part and the second uneven part are engaged with each other.

7. The wheel assembly according to claim 6, wherein the shaft member is movable along a direction of the first axis; and the position determiner further comprises an uneven member formed with a through hole in which the shaft member is inserted in the direction of the first axis and having an uneven part on an outer periphery, a third uneven part formed in the base block and always engaging with the uneven member and selectively engaging with the first uneven part, and a fourth uneven part provided in the other end part of the wheel support and selectively engaging with the uneven member,
the first uneven part being engaged with the second uneven part and the third uneven part and the uneven member being engaged with the fourth uneven part to fix the position of the wheel support when the wheel support is located at the first position or the second position, and
the first uneven part being released from the third uneven part and the uneven member being released from the fourth uneven part to make the wheel support be rotatable when the wheel support pivots between the first position and the second position.

8. The wheel assembly according to claim 7, further comprising a first elastic member that is put on the shaft member and disposed concentrically with the shaft member and elastically urges the shaft member in a direction that the first uneven part engages with the third uneven part.

9. The wheel assembly according to claim 1, wherein the wheel support comprises a first support member pivotable on the first axis with regard to the base block, and a second support member having one end part coupled being pivotable on a second axis intersecting the first axis with regard to the first support member and the other end part to which the wheel is rotatably coupled,
the second support member pivots on the second axis with regard to the first support member while the first support member rotates between the first position and the second position.

10. Wheeled shoes comprising
an outer cover a wearer's foot
a sole coupled to a bottom of the outer cover to contact the ground; and
a wheel assembly, according to claim 1, installed to be retracted into or pulled out of an inner space provided in the sole.
